(19) United States
(12) Patent Application Publication
(10) Pub. No.: US 2002/0114443 A1
(43) Pub. Date: Aug. 22, 2002

(54) Communication systems

(76) Inventors: Gunnar Klinghult, Lund (SE); Peter Rojsel, Lund (SE)

Correspondence Address: Ronald L. Grudziecki, BURNS, DOANE, SWECKER & MATHIS, L.L.P., P.O. Box 1404, Alexandria, VA, 22313-1404, US

(21) Appl. No.: 10/011,439

(22) Filed: Dec. 11, 2001

Related U.S. Application Data
(60) Provisional application No. 60/255,406, filed on Dec. 15, 2000.

(30) Foreign Application Priority Data
Dec. 12, 2000 (GB) 0030279.4

(51) Int. Cl. H04M 1/00; H04M 9/00

(52) U.S. Cl. 379/388.01

(57) ABSTRACT

There is provided a mobile telephone in which a class D amplifier is used to amplify the signals supplied to a loudspeaker. The baseband receiver circuitry, which remains switched on while the transmitter is active, processes only digital signals, thereby avoiding the “bumble bee” effect caused by signals from the transmitter interfering with signals in the receiver circuitry.

The present invention relates to communication systems, and in particular, to communication systems utilising radio frequency (RF) signals.

### BACKGROUND OF THE INVENTION

Mobile telecommunication systems make use of radio frequency (RF) signals to communicate with mobile terminals such as mobile telephones. Mobile telephones and audio accessories for mobile telephones must have at least one audio amplifier in order to reproduce sound from a phone call or other audio signal for output to a user via a loudspeaker. Conventional solutions provide a class A, AB or B amplifier as the audio amplifier in such terminals. However, such amplifiers are sensitive to RF signals, and so various techniques are used to minimise RF interference in audio circuits today. Each circuit (each product) needs its own different solution to minimise the RF interference. There is thus no “standard” solution to use in all cases. Used techniques include the addition of decoupling capacitors or inductors in the audio paths and on supply leads. This will often impair the audio performance in other ways and is thus almost always a compromise.

As mentioned, audio amplifiers used in conventional mobile telephones are sensitive to radio frequency. Digital communication systems often use pulsed RF signals, for example in GSM the transmitter is pulsed with a 217 Hz which can be heard as a bumble bee like sound in the loudspeaker after unintentional detection in the analogue audio amplifier. In the Bluetooth (TM) wireless system the RF is pulsed at 1600 Hz, and this can be heard as a high pitch whine.

It is anticipated that future mobile telephones will make use of large piezo electric loudspeakers, which creates the need for high drive voltages to the speaker since it has very high impedance. This further implies that the use of conventional audio amplifiers will result in increased sensitivity to RF disturbances.

In addition, functions like the MPEG3 audio player require a fairly high audio output and when in use tends to be used for extended periods of time which consumes a large amount of power.

It is therefore desirable to provide an audio amplifier for a mobile telephone which can avoid the RF interference and reduce the amount of battery power used.

### SUMMARY OF THE PRESENT INVENTION

According to one aspect of the present invention, there is provided a mobile telephone which includes an audio output stage for supplying audio signals to a loudspeaker, wherein the audio amplifier stage is provided by a class D amplifier.

It is emphasised that the term “comprises” or “comprising” is used in this specification to specify the presence of stated features, integers, steps or components, but does not preclude the addition of one or more further features, integers, steps or components, or groups thereof.

### BRIEF DESCRIPTION OF THE DRAWINGS

FIGS. 1 and 2 illustrate respective previously-considered audio amplifiers for use in mobile telephones; and

FIG. 3 illustrates an audio amplifier embodying the present invention for use in a mobile telephone.

FIG. 4 shows a mobile telephone incorporating the audio amplifier of FIG. 3.

### DETAILED DESCRIPTION OF THE PREFERRED EMBODIMENT

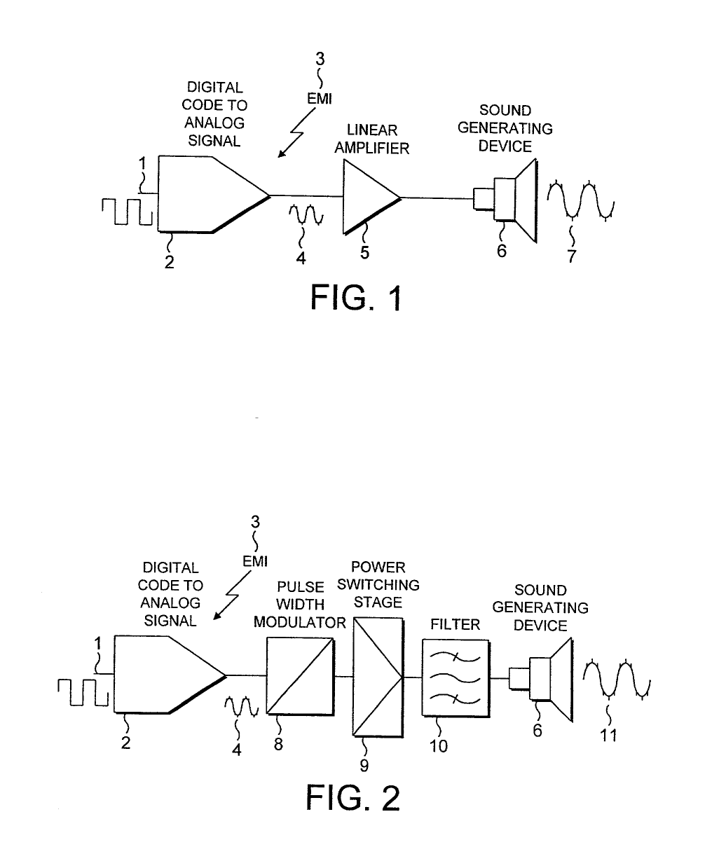

FIG. 1 illustrates a previously considered audio amplifier for use in a mobile telephone. The audio amplifier receives a digital encoded signal 1 from the digital mobile telephone circuitry (not shown). The digital encoded signal 1 is converted to an analogue signal 4 by a digital/analogue converter 2. Typically, the digital encoded signal would be a pulse code modulated signal received from a speech coder/decoder (codec) device. The analogue signal 4 is particularly susceptible to interference from electromagnetic RF signals (EMI) 3, which cause the signal 4 to become noisy.

The analogue signal 4 is amplified by a linear amplifier 5 and is supplied to a sound generating device 6. The sound generating device 6 outputs an audio signal 7, which is an amplified version of the analogue signal 4.

FIG. 2 illustrates a second previously considered audio amplifier for use in a mobile telephone. U.S. Pat. No. 5,410,592 shows a class D audio amplifier for driving a paging loudspeaker in a fixed line telephone. The FIG. 2 amplifier is similar to the FIG. 1 amplifier, with the exception that the linear amplifier 5 of FIG. 1 is replaced by three components in the FIG. 2 device. The analogue signal 4 produced by the digital analogue converter unit 2 is converted to a pulse width modulated signal for input to a power switching stage 9. A band pass filter 10 filters the output from the power switching stage, for supply to the sound generating device 6. The sound generating device 6 produces an audio output signal 11. As with the FIG. 1 embodiment, the amplifier suffers from signal degradation due to electromagnetic interference 3 interfering with the analogue signal 4.

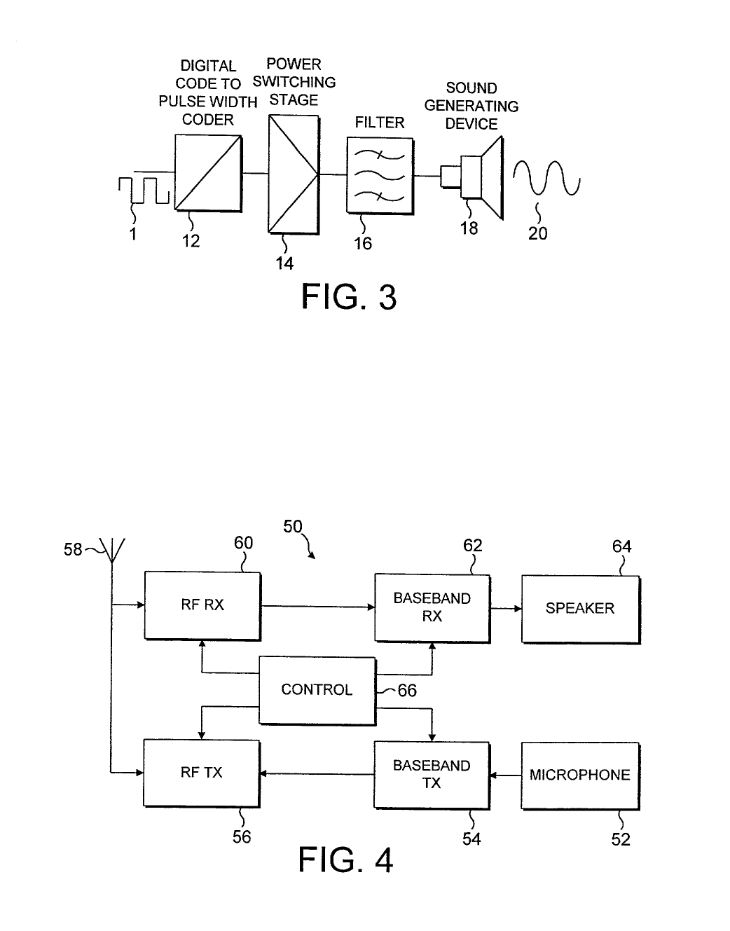

FIGS. 3 and 4 illustrate one embodiment of the present invention which overcomes the disadvantages of the amplifiers of FIGS. 1 and 2.

FIG. 4 shows a digital mobile phone 50, for example operating in the GSM system, although the invention is applicable to all devices which transmit under any Time Division Multiple Access (TDMA) system, or under the Wideband Code Division Multiple Access (WCDMA) system. For example, the invention is generally applicable to portable radio communication equipment or mobile radio terminals, such as mobile telephones, pagers, communicators, electronic organisers, smartphones, personal digital assistants (PDAs), or the like, and the term “mobile telephone” is used broadly to encompass all such devices.

Speech inputs at a microphone 52 are processed at baseband in circuitry 54, then upconverted to RF and further processed, for example amplified, in RF transmitter circuitry 56. The resulting signals are transmitted over the air interface by an antenna 58.

Signals received at the antenna 58 are supplied to RF receiver circuitry 60, where they are downconverted to baseband and converted to digital form, and they are then processed in digital baseband receiver circuitry 62. The resulting signals are used to drive a loudspeaker 64.

The baseband and RF circuit blocks 54, 56, 60, 62 are controlled by control circuitry 66. In particular, in a system as shown, the antenna can either receive or transmit signals at any time. When the RF transmitter circuitry 56 is switched on, the RF receiver circuitry 60 is switched off, and vice versa. However, the digital baseband receiver circuitry 62 remains switched on even when the RF receiver circuitry 60 is switched off, so that it can provide a continuous output to the user.

The digital baseband receiver circuitry 62 can also receive other digital input signals, for example an input from an MP3 or other audio player, which can for example be connected as an accessory to the phone 50.

FIG. 3 is a block schematic diagram showing relevant parts of the digital baseband circuitry 62, including a digital code to pulse width encoder 12 which receives a digital encoded signal 1 from the speech decoder of the mobile telephone, and converts it to a pulse width modulated (PWM) signal. That is, the widths of the pulses in the PWM signal then carry the audio information. The pulse width modulated signal is supplied to a power switching stage 14 which amplifies the signal and supplies an output to a band pass filter 16. The band pass filter 16 filters the signal to provide a suitable driving signal for supply to a sound generating device 18 (the speaker 64 in FIG. 4) which outputs a clean audio signal 20.

It will be appreciated that the power switching stage 14 and filter 16 provide a class D amplifier. The basic power output stage of a class D amplifier is a switching stage and thus operates digitally. This gives a low output impedance with only fully switched on or fully switched off transistors. The class D amplifier can thus not detect RF signals, and cannot be subject to RF interference. In addition, a class D amplifier has a theoretical efficiency of up to 100% and an efficiency of 90 to 98% in real applications.

Driving the loudspeaker with a digital signal via such a class D amplifier in a mobile telephone or its accessories gives various benefits. The use of a class D amplifier achieves elimination of RF disturbances, provides greater efficiency for power use, it eliminates a lot of analogue circuitry which leads to simpler and smaller circuitry, the class of the amplifier has lower current consumption, lower power dissipation and uses less silicon area than the previously considered audio amplifier stages. In addition, a class D amplifier can generate high voltages required to drive a piezo electric loudspeaker.

Further, in accordance with the invention, there is no analogue signal present in the part of the circuitry which remains switched on at all times. Since it is such analogue signals which are subject to interference from the transmitter to produce the “bumble bee” interference mentioned previously, the circuit as described herein avoids this problem.

There is thus described a circuit which is efficient and also provides a high quality audio output.

1. A digital mobile telephone comprising:
digital circuitry which is operable to output encoded digital signals representing audio signals; and
an audio output stage connected for receiving encoded digital signals from the digital circuitry and operable to output drive signals for driving an audio output device,
wherein the audio output stage includes a class D amplifier which is connected for receiving the encoded digital signals and is operable to output amplified digital signals as the output drive signals.

2. A mobile telephone as claimed in claim 1, wherein the audio output stage comprises:
an encoder which is connected to receive the encoded digital signal from the digital circuitry, and is operable to convert received signals to pulse width coded digital signals.

3. A mobile telephone as claimed in claim 2, wherein the audio output stage comprises:
a power switching unit connected to receive pulse width coded signals from the encoder and operable to output amplified digital signals; and
a filter connected to receive amplified digital signals from the power switching unit and operable to supply a filtered output signal to a sound generating device.

4. A mobile telephone as claimed in claim 3, wherein the filter is a band pass filter.

5. A mobile telephone as claimed in claim 1, comprising:
transmitter circuitry; and
RF receiver circuitry;
wherein the RF receiver circuitry is switched off when the transmitter circuitry is active, while the digital circuitry and audio output stage remain switched on.
